(19) United States
(12) Patent Application Publication
(10) Pub. No.: US 2026/0197674 A1
(43) Pub. Date: Jul. 9, 2026

(54) CELLULAR NETWORK INTELLIGENCE GATHERING VIA SPACE MOBILE SYSTEMS

(71) Applicant: T-MOBILE INNOVATIONS LLC, Overland Park, KS (US)

(72) Inventor: Akin OZOZLU, McLean, VA (US)

(21) Appl. No.: 19/013,981

(22) Filed: Jan. 8, 2025

(51) Int. Cl. H04W 24/02; H04B 17/318; H04W 40/24; H04W 84/06

(52) U.S. Cl. CPC H04W 24/02; H04B 17/318; H04W 40/248; H04W 84/06

(57) ABSTRACT

The technology disclosed herein relates to identifying terrestrial network coverage gaps using real-time data gathered by space mobile systems. Initially, a dummy PLMN ID is assigned to a space mobile satellite system. The dummy PLMN ID is leveraged for intelligence gathering. RACH and location and routing area updates (LAU/RAU) are collected as a function of beam location for the terrestrial network. Based on the original SIM card assigned to IMSI and LAU/RAU, coverage deficiencies can be categorized for an MNO or a competitor of the MNO. To do so, signal strengths can be identified via brute force PCI scanning. Using the identified signal strengths, coverage maps can be generated for the MNO or the competitor of the MNO. In some aspects, demand based on RACH/LAU attempts in the coverage gap can be defined and used to weight the importance of the coverage gap.

### SUMMARY

This summary is not intended to identify key features or essential features of the claimed subject matter, nor is it intended to be used as an aid in isolation to determine the scope of the claimed subject matter. The present disclosure is directed, in part, to technology associated with cellular network intelligence gathering via space mobile systems, substantially as shown in and/or described in connection with at least one of the figures, and as set forth more completely in the claims.

In aspects set forth herein, and at a high level, the technology described herein relates to identifying terrestrial network coverage gaps using real-time data gathered by space mobile systems. Initially, a dummy public land mobile network (PLMN) identifier (ID) is assigned to a space mobile satellite system. The dummy PLMN ID is leveraged for intelligence gathering. Random access channel (RACH) and location and routing area updates (LAU/RAU) are collected as a function of beam location for the terrestrial network. Based on the original subscriber identity module (SIM) card assigned to International Mobile Subscriber Identity (IMSI) and LAU/RAU, coverage deficiencies can be categorized for a mobile network operator (MNO) or a competitor of the MNO. To do so, signal strengths can be identified via brute force physical cell identity (PCI) scanning. Using the identified signal strengths, coverage maps can be generated for the MNO or the competitor of the MNO. In some aspects, demand based on RACH/LAU attempts in the coverage gap can be defined and used to weight the importance of the coverage gap.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE SEVERAL VIEWS OF THE DRAWINGS

Implementations of the present disclosure are described in detail below with reference to the attached drawing figures, wherein:

FIG. 1 depicts an example operating environment for identifying terrestrial network coverage gaps using real-time data gathered by space mobile systems, in accordance with aspects herein;

FIG. 2 depicts an example coverage gap engine, in accordance with aspects herein;

FIG. 3 illustrates an example flowchart for identifying terrestrial network coverage gaps using real-time data gathered by space mobile systems, in accordance with aspects herein;

FIG. 4 depicts an example satellite for use in implementations of the present disclosure, in accordance with aspects herein; and

FIG. 5 depicts an example user device suitable for use in implementations of the present disclosure, in accordance with aspects herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Throughout this disclosure, several acronyms and shorthand notations are employed to aid the understanding of certain concepts pertaining to the associated system and services. These acronyms and shorthand notations are intended to help provide an easy methodology of communicating the ideas expressed herein and are not meant to limit the scope of embodiments described in the present disclosure. The following is a list of these acronyms:

| | |
|---|---|
| 3G | Third-Generation Cellular Communication System |
| 4G | Fourth-Generation Cellular Communication System |
| 5G | Fifth-Generation Cellular Communication System |
| CD-ROM | Compact Disk Read Only Memory |
| CDMA | Code Division Multiple Access |
| eNB | Evolved Node B |
| gNB | Next Generation Node B |
| GPRS | General Packet Radio Service |
| GSM | Global System for Mobile communications |
| DVD | Digital Versatile Discs |
| EEPROM | Electrically Erasable Programmable Read Only Memory |
| EN-DC | E-UTRA NR Dual Connectivity |
| E-UTRA | Evolved Universal Terrestrial Radio Access |
| E-UTRAN | Evolved Universal Terrestrial Radio Access Network |
| Ev-DO | Evolution Data Optimized |
| FD-MIMO | Full-Dimension Multiple-Input Multiple-Output |
| GPS | Global Positioning System |
| IoT | Internet of Things |
| LAN | Local Area Network |
| LTE | Long Term Evolution |
| MIMO | Multiple-Input Multiple-Output |
| mm wave | Millimeter wave |
| MME | Mobility Management Entity |
| MU-MIMO | Multi-User Multiple-Input Multiple-Output |
| NAT | Network Access Technology |
| NR | New Radio |
| PC | Personal Computer |
| PDA | Personal Digital Assistant |
| PLMN | Public Land Mobile Network |
| RAM | Random Access Memory |
| RAN | Radio Access Network |
| RF | Radio-Frequency |
| ROM | Read Only Memory |
| RRC | Radio Resource Control |
| RSRP | Reference Signal Received Power |
| RSRQ | Reference Transmission Receive Quality |
| RSSI | Received Signal Strength Indicator |
| SNR | Signal-to-Noise Ratio |
| SRS | Sound Reference Signal |
| TDMA | Time Division Multiple Access |
| VLAN | Virtual Local Area Network |

In addition, words such as “a” and “an,” unless otherwise indicated to the contrary, may also include the plural as well as the singular. Thus, for example, the constraint of “a feature” is satisfied where one or more features are present. Furthermore, the term “or” includes the conjunctive, the disjunctive, and both (a or b thus includes either a or b, as well as a and b).

Unless specifically stated otherwise, descriptors such as “first,” “second,” and “third,” for example, are used herein without imputing or otherwise indicating any meaning of priority, physical order, arrangement in a list, or ordering in any way, but are merely used as labels to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

Further, the term “some” may refer to “one or more.” Additionally, an element in the singular may refer to “one or more.” The term “plurality” may refer to “more than one.”

The term “combination” (e.g., one or more combinations thereof) may refer to, for example, “at least one of A, B, or C”; “at least one of A, B, and C”; “at least two of A, B, or C” (e.g., AA, AB, AC, BB, BA, BC, CC, CA, CB); “each of A, B, and C”; and may include multiples of A, multiples of B, or multiples of C (e.g., CCABB, ACBB, ABB, etc.). Other combinations may include more or less than three options associated with the A, B, and C examples.

As used herein, the phrase “based on” shall be construed as a reference to an open set of conditions. For example, an example step that is described as “based on X” may be based on both X and additional conditions, without departing from the scope of the present disclosure. In other words, as used herein, the phrase “based on” shall be construed in the same manner as the phrase “based at least in part on.”

A “wireless telecommunication service” refers to the transfer of information without the use of an electrical conductor as the transferring medium. Wireless telecommunication services may be provided by one or more telecommunication network providers. Wireless telecommunication services may include, but are not limited to, the transfer of information via radio waves (e.g., Bluetooth®), satellite communication, infrared communication, microwave communication, Wi-Fi, mm wave communication, and mobile communication. Embodiments of the present technology may be used with different wireless telecommunication technologies or standards, including, but not limited to, CDMA 1xAdvanced, GPRS, Ev-DO, TDMA, GSM, WiMAX technology, LTE, LTE Advanced, other technologies and standards, or one or more combinations thereof. For example, in an embodiment, the present technology discussed herein may be used in a 3GPP-based system.

A “network” can provide one or more wireless telecommunication services and may transmit or receive a wireless signal to or from a user device. In embodiments, a network may be one or more telecommunications networks, or a portion thereof. The network might include an array of devices or components (e.g., one or more base stations). Additionally or alternatively, the network can include multiple networks, and the network can be a network of networks. In embodiments, the network or a portion thereof may be a core network, such as an evolved packet core or 5G core, which may include a control plane entity (e.g., a mobility management entity), a user plane entity (e.g., a serving gateway), and an access and mobility management function. In some embodiments, the network may comprise one or more public or private networks—wherein one or more of which may be configured as a satellite network (e.g., a 3GPP non-terrestrial network), a publicly switched telephony network, a cellular telecommunications network, another type of network, or one or more combinations thereof.

In embodiments, the network may comprise a satellite network connecting one or more gateways (e.g., a device or a system of components configured to provide an interface between the network and a satellite) to other networks, a cellular core network (e.g., a 4G, 5G, of 6G core network, an IMS network, and the like), a data network, another type of network, or one or more combinations thereof. In such embodiments, each of the satellite network and the cellular core network may be associated with a network identifier, such as a public land mobile network (PLMN), a mobile country code, a mobile network code, or the like, wherein the network identifier associated with the satellite network is the same or different than the network identifier associated with the cellular network.

In embodiments, the network (including the satellite network) can connect one or more user devices to a service provider for services such as (e.g., 3G network, 4G network, LTE network, 5G network, NR, and the like), for example. In aspects, a service provided to a user device may comprise one or more of a voice service, a message service (e.g., SMS messages, MMS messages, instant messaging messages, an EMS service messages), a data service, other types of wireless telecommunication services, or one or more combinations thereof. The network can comprise any communication network providing voice, message, or data service(s), such as, for example, a 1x circuit voice, a 3G network (e.g., CDMA, CDMA2000, WCDMA, GSM, UMTS), a 4G network (WiMAX, LTE, HSDPA), a 5G network, a 6G network, another generation network, or one or more combinations thereof. Components of the network, for example, may include terminals, links, gateways, nodes (e.g., a core network node), relay devices, integrated access and backhaul nodes, other types of network components, or one or more combinations thereof.

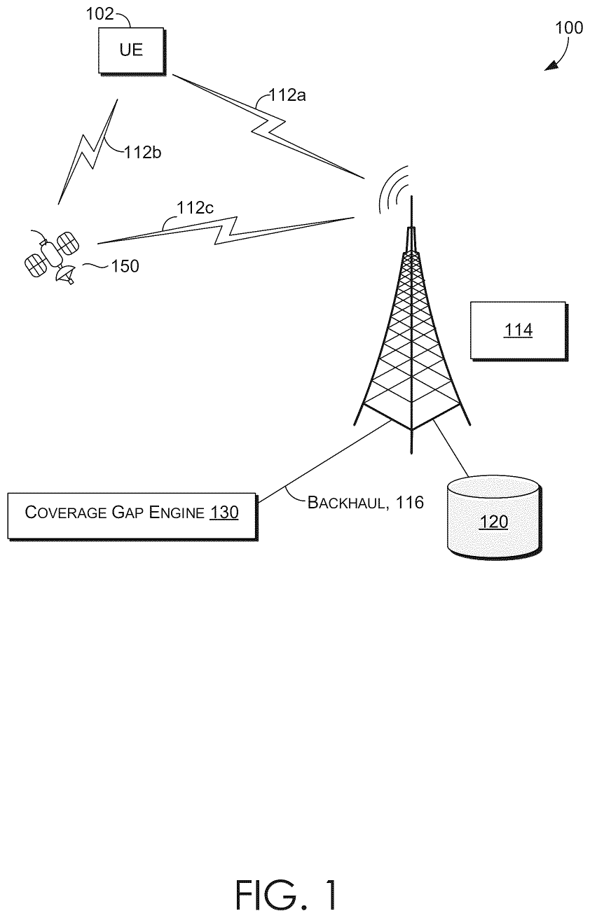

As used herein, the term “base station” refers to a centralized component or system of components configured to wirelessly communicate (e.g., receive and/or transmit signals) with various devices or components (e.g., a user device, a relay device) in a particular geographical area. A base station may be referred to as one or more cell sites, nodes, gateways, remote radio unit control components, base transceiver stations, access points, NodeBs, eNBs, gNBs, Home NodeBs, Home eNodeBs, macro base stations, small cells, femtocells, relay base stations, another type of base station, or one or more combinations thereof. A base station may be, in an embodiment, similar to access point 114 described herein with respect to FIG. 1.

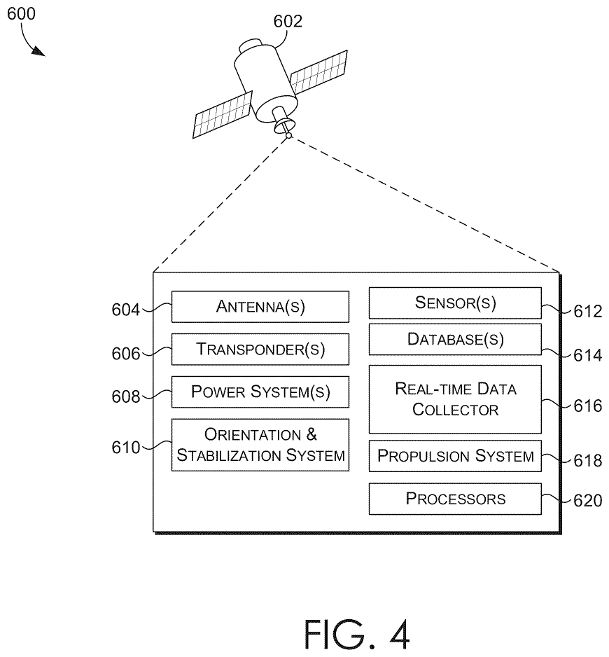

The term “satellite,” as used herein, is an extraterrestrial base station that is distinguished from a terrestrial base station on the basis of its lack of ground coupling. Some examples of a satellite can include a space satellite, a balloon, a dirigible, an airplane, a drone, an unmanned aerial vehicle, a geosynchronous or geostationary earth orbit satellite, a low earth orbit satellite, a medium earth orbit satellite, a bent-pipe satellite, a regenerative satellite, another type of satellite, or one or more combinations thereof. A satellite may be, in an embodiment, similar to satellite 150 described herein with respect to FIG. 1 or satellite 402 described herein with respect to FIG. 4.

Embodiments of the technology described herein may be embodied as, among other things, a method, system, or computer-program product. Accordingly, the embodiments may take the form of a hardware embodiment, or an embodiment combining software and hardware. An embodiment that takes the form of a computer-program product can include computer-useable instructions embodied on one or more computer-readable media.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal (e.g., a modulated data signal referring to a propagated signal that has one or more of its characteristics set or changed to encode information in the signal). Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

Satellite RANs are being integrated with cellular telecommunication networks (e.g., in a 3GPP-based system). In various topographies of a terrestrial geographical area, as well as during early phases of satellite deployments, there may be locations where a user device will be beyond the reach of a terrestrial RAN or within a coverage gap of the terrestrial RAN (e.g., a terrestrial RAN corresponding to an MNO or a competitor of the MNO). Traditionally terrestrial cellular access network coverage design is based on the knowledge of a local radio frequency (RF) engineer (such as by implementing drive tests) or map-based propagation tool estimations. Both methods are highly dependent on input data and are highly variable often causing coverage deficiencies, incorrect coverage designs, and/or unnecessary network tower investments. Moreover, drive tests are cost-prohibitive and have been abandoned in most cases. Accordingly, in conventional systems, there is no practical method to collect data terrestrial networks of the MNO or the competitor MNO.

Accordingly, aspects of the present disclosure are directed to identifying terrestrial network coverage gaps using real-time data gathered by space mobile systems. In aspects, actual real-time data for terrestrial networks of the MNO or the competitor MNO can be collected. In this way, coverage deficiencies can be categorized for a mobile network operator (MNO) or a competitor of the MNO. As a result, coverage designs and/or network tower investments can be accurately and precisely implemented.

In an embodiment, a system is provided for identifying terrestrial network coverage gaps using real-time data gathered by space mobile systems. The system comprises one or more processors and computer memory storing computer-usable instructions that, when executed by the one or more processors, cause the one or more processors to perform operations. The operations comprise assigning a dummy public land mobile network (PLMN) identifier (ID) to a space mobile satellite. The operations also comprise receiving, from the space mobile satellite, a random access channel (RACH) and location and routing area updates (LAU/RAU) as a function of beam location for a terrestrial network. The operations further comprise, based on a subscriber identity module (SIM) assigned to an international mobile subscriber identity (IMSI) of one or more user devices, categorizing a coverage deficiency for a terrestrial network.

In another embodiment, a method is provided for identifying terrestrial network coverage gaps using real-time data gathered by space mobile systems. The method comprises assigning a dummy public land mobile network (PLMN) identifier (ID) to a space mobile satellite. The method also comprises receiving, from the space mobile satellite, a random access channel (RACH) and location and routing area updates (LAU/RAU) as a function of beam location for a terrestrial network. The method further comprises, based on a subscriber identity module (SIM) assigned to an international mobile subscriber identity (IMSI) of one or more user devices, categorizing a coverage deficiency for a terrestrial network.

Another embodiment includes one or more non-transitory computer storage media having computer-executable instructions embodied thereon, that when executed by at least one processor, cause the at least one processor to perform a method. The method comprises assigning a dummy public land mobile network (PLMN) identifier (ID) to a space mobile satellite. The method also comprises receiving, from the space mobile satellite, a random access channel (RACH) and location and routing area updates (LAU/RAU) as a function of beam location for a terrestrial network. The method further comprises, based on a subscriber identity module (SIM) assigned to an international mobile subscriber identity (IMSI) of one or more user devices, categorizing a coverage deficiency for a terrestrial network.

FIG. 1 depicts a wireless network environment 100 in which implementations of the present disclosure may be employed. Such a network environment is illustrated and designated generally as network environment 100. Network environment 100 is not to be interpreted as having any dependency or requirement relating to any one or combination of components illustrated.

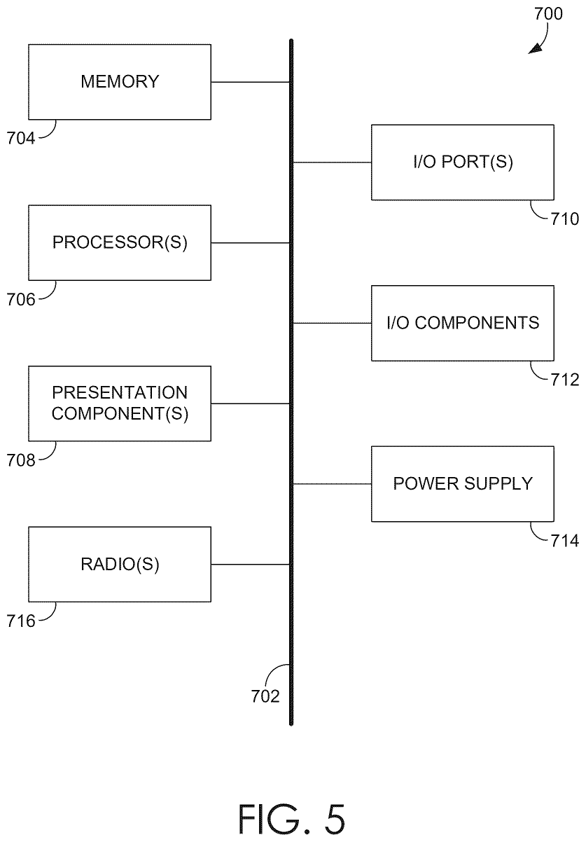

Network environment 100 includes user device (UE) 102, access point 114 (which may be a cell site, base station, or the like), satellite 150, and one or more communication channels 112a, 112b, 112c. In network environment 100, user device may take on a variety of forms, such as a personal computer (PC), a user device, a smart phone, a smart watch, a laptop computer, a mobile phone, a mobile device, a tablet computer, a wearable computer, a personal digital assistant (PDA), a server, a CD player, an MP3 player, a global positioning system (GPS) device, a video player, a handheld communications device, a workstation, a router, a hotspot, and any combination of these delineated devices, or any other device (such as the computing device) that communicates via wireless communications with the access point 114 and/or satellite 150 in order to interact with a public or private network. A user device may be, in an embodiment, user device 102 described herein with respect to FIG. 1 or user device 500 described herein with respect to FIG. 5.

In embodiments, a user device may include internet-of-things devices, such as one or more of the following: a sensor, controller (e.g., a lighting controller, a thermostat), appliances (e.g., a smart refrigerator, a smart air conditioner, a smart alarm system), other internet-of-things devices, or one or more combinations thereof. Internet-of-things devices may be stationary, mobile, or both. In some aspects, the user device is associated with a vehicle (e.g., a video system in a car capable of receiving media content stored by a media device in a house when coupled to the media device via a local area network). In some aspects, the user device comprises a medical device, a location monitor, a clock, other wireless communication devices, or one or more combinations thereof.

In some aspects, the user device is a wearable device having a camera, microphone, RFID, GPS, another sensor, or one or more combinations thereof. A wearable device (or another type of user device) can transmit the data obtained by their corresponding sensor(s) (e.g., to another user device, to a server). In embodiments, a user device can access sensors, application data, tracking data, map data, other user device data, or one or more combinations thereof, for packet transmissions (e.g., to another user device). In some embodiments, a wearable device can be a watch-type electronic device, a glasses-type wearable device, an upper-torso wearable device, another type of wearable device, or one or more combinations thereof.

In some aspects, UE 102 may correspond to computing device 500 in FIG. 5. Thus, a UE can include, for example, a display(s), a power source(s) (e.g., a battery), a data store(s), a speaker(s), memory, a buffer(s), a radio(s) and the like. In some implementations, for example, a UE 102 may comprise a wireless or mobile device with which a wireless telecommunication network(s) can be utilized for communication (e.g., voice and/or data communication). In this regard, the user device can be any mobile computing device that communicates by way of a wireless network, for example, a 4G, 5G, of 6G core network, an IMS network, and the like, a data network, another type of network, or one or more combinations thereof.

In some cases, UE 102, in network environment 100 can optionally utilize one or more communication channels 112a, 112b to communicate with other computing devices (e.g., a mobile device(s), a server(s), a personal computer(s), etc.) through access point 114 or satellite 150. The network environment 100 may be comprised of a telecommunications network(s), or a portion thereof. A telecommunications network might include an array of devices or components (e.g., one or more base stations), some of which are not shown. Those devices or components may form network environments similar to what is shown in FIG. 1, and may also perform methods in accordance with the present disclosure. Components such as terminals, links, and nodes (as well as other components) can provide connectivity in various implementations. Network environment 100 can include multiple networks, as well as being a network of networks, but is shown in more simple form so as to not obscure other aspects of the present disclosure.

The one or more communication channels 112a, 112b, 112c can be part of a telecommunication network that connects subscribers to their immediate telecommunications service provider (i.e., home network carrier). In some instances, the one or more communication channels 112a, 112b, 112c can be associated with a telecommunications provider that provides services (e.g., 3G network, 4G network, LTE network, 5G network, NR, and the like) to user devices, such as UE 102. For example, the one or more communication channels (such as communication channel 112a) may provide voice, SMS, and/or data services to UE 102, or corresponding users that are registered or subscribed to utilize the services provided by the telecommunications service provider. The one or more communication channels 112a, 112b, 112c can comprise, for example, a 1x circuit voice, a 4G, 5G, of 6G core network, an IMS network, and the like, a data network, another type of network, or one or more combinations thereof.

In some implementations, access point 114 is configured to communicate with a UE, such as UE 102, located within the geographic area, or cell, covered by radio antennas of access point 114. An access point 114 may include one or more base stations, base transmitter stations, radios, antennas, antenna arrays, power amplifiers, transmitters/receivers, digital signal processors, control electronics, GPS equipment, and the like. In particular, access point 114 may selectively communicate with the user devices. In some implementations, satellite 150 is configured to communicate with UE, such as UE 102, when satellite 150 passes through the geographic area, or cell, where UE is currently located.

As shown, access point 114 is in communication with coverage gap engine 130 and at least a network database 120 via a backhaul channel 116. Access point 114 is also in communication with satellite 150 via communication channel 112c enabling satellite 150 to communicate data (such as data described herein) to access point 114 and/or coverage gap engine 130. Access point 114 may store data, such as data, as described herein, received from satellite 150, at a network database 120. Alternatively, coverage gap engine 130 may automatically retrieve the data from access point 114, and similarly store the data in the network database 120. In some aspects, satellite 150 receives data from UE 102 via communicate channel 112b and communicates the data to access point 114 (or core network or coverage gap engine 130) via communication channel 112c. The data may be communicated or retrieved and stored in real-time or periodically within a predetermined time interval which may be in seconds, minutes, hours, days, months, years, and the like. With the incoming of new data, the network database 120 may be refreshed with the new data every time, or within a predetermined time threshold so as to keep the status data stored in the network database 120 current.

The coverage gap engine 130 is generally configured to communicate with the access point 114, the network database 120, and/or the satellite 150 to identifying terrestrial network coverage gaps using real-time data gathered by space mobile systems. All data communicated to, received by, or further generated by the coverage gap engine 130 may be stored at the network database 120. In aspects, the coverage gap engine receives data from the satellite 150 and identifies coverage gaps corresponding to the MNO or a competitor of the MNO.

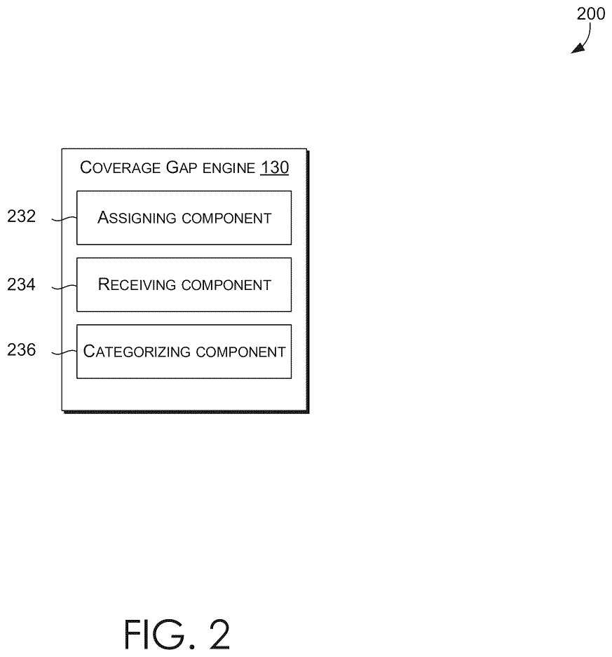

Referring now to FIG. 2, the coverage gap engine 130 comprises various components including an assigning component 232, receiving component 234, and categorizing component 236. Although the coverage gap engine 130 is shown as a single component comprising the assigning component 232, receiving component 234, and categorizing component 236, it is also contemplated that each of the assigning component 232, receiving component 234, and categorizing component 236 may reside at different locations (such as the access point, the satellite, or the core network), be its own separate entity, and the like, within the home network carrier system.

The assigning component 232, a dummy public land mobile network (PLMN) identifier (ID) is assigned to a space mobile satellite. The dummy PLMN ID can be utilized to receive data from a UE without providing any services to the UE. In aspects, the satellite communicates received data to an access point or the core network via a second dummy PLMN ID assigned to the access point or the core network.

The receiving component 234 receives a RACH and LAU/RAU as a function of beam location for a terrestrial network from the space mobile satellite. In some aspects, the receiving component receives a signal strength corresponding to the one or more user devices via brute force PCI scanning may be identified. Utilizing the signal strength corresponding to the one or more user devices, a coverage map for the MNO or the competitor MNO is generated by the receiving component 234. In this way, a coverage gap for the MNO or the competitor MNO can be identified.

In some aspects, receiving component 234 defines demand based on the RACH and the LAU/RAU attempts within the coverage gap. Based on the demand, an importance of the coverage gap can be determined. For example, if the demand meets or exceeds a particular threshold (based on a count of the RACH and LAU/RAU attempts), the importance of the coverage gap may indicate the MNO needs to take action, such as installing a new access point, altering the beamforming of the existing access point, or increasing the power provided to or utilized by the existing access point. In another example, if the demand is less than a particular threshold (based on a count of the RACH and LAU/RAU attempts), the importance of the coverage gap may indicate the MNO does not need to take immediate action.

The categorizing component 236 categorizes a coverage deficiency for a terrestrial network based on a SIM assigned to an IMSI of one or more user devices. For example, the coverage deficiency can be categorized as a coverage gap of the MNO. In another example, the coverage deficiency can be categorized as a coverage gap of a competitor MNO.

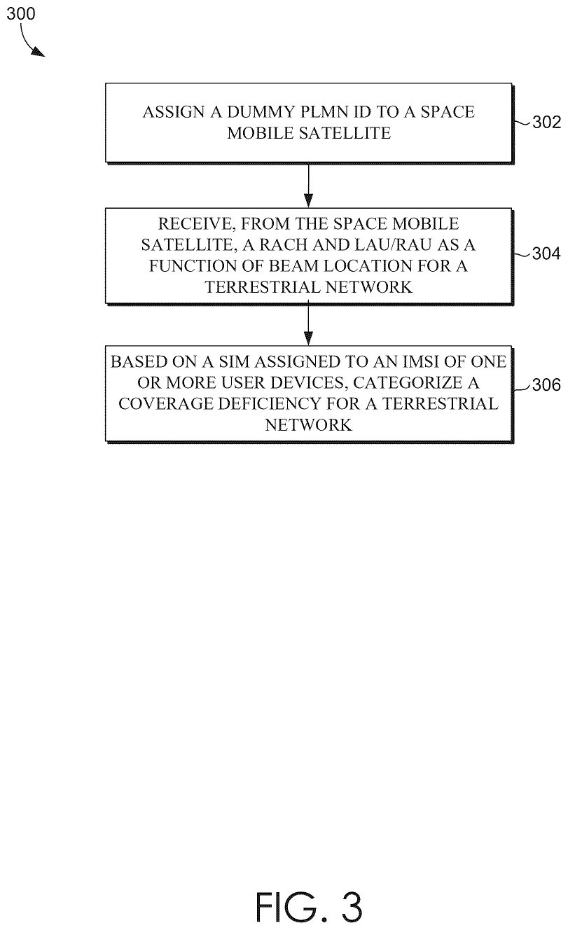

In FIG. 3, a flow diagram is provided depicting a method 300 for identifying terrestrial network coverage gaps using real-time data gathered by space mobile systems, in accordance with aspects of the present invention. Method 300 may be performed by any computing device (such as computing device described with respect to FIG. 5) with access to coverage gap engine (such as the one described with respect to FIGS. 1 and 2) or by one or more components of the network environment described with respect to FIG. 1 (such as access point 114, coverage gap engine 130, or satellite). Initially at step 302, a dummy public land mobile network (PLMN) identifier (ID) is assigned to a space mobile satellite. The dummy PLMN ID can be utilized to receive data from a UE without providing any services to the UE. In aspects, the satellite communicates received data to an access point or the core network via a second dummy PLMN ID assigned to the access point or the core network.

At step 304, a random access channel (RACH) and location and routing area updates (LAU/RAU) as a function of beam location for a terrestrial network are received from the space mobile satellite. At step 306, based on a subscriber identity module (SIM) assigned to an international mobile subscriber identity (IMSI) of one or more user devices, a coverage deficiency for a terrestrial network is categorized. For example, the coverage deficiency can be categorized as a coverage gap of the MNO. In another example, the coverage deficiency can be categorized as a coverage gap of a competitor MNO.

In some aspects, a signal strength corresponding to the one or more user devices via brute force physical cell identity (PCI) scanning is identified. In some aspects, the brute force PCI comprises altering the PCI for each satellite pass. For example, on each pass, one or more PCI may be changed (such as by incrementing the PCI from the previous pass) and data can be collected from the UE to assess how strong the signal strength (e.g., reference signal received power (RSRP)/received signal strength indicator (RSSI)) is for the MNO network and/or a competitor MNO network. In some aspects, multiple satellites can be utilized to identify and communicate data to access point, core network, or coverage gap engine. Utilizing the signal strength corresponding to the one or more user devices, a coverage map for the MNO or the competitor MNO is generated. In this way, a coverage gap for the MNO or the competitor MNO can be identified.

In some aspects, demand based on the RACH and the LAU/RAU attempts within the coverage gap can be defined. Based on the demand, an importance of the coverage gap can be determined. For example, if the demand meets or exceeds a particular threshold (based on a count of the RACH and LAU/RAU attempts), the importance of the coverage gap may indicate the MNO needs to take action, such as installing a new access point, altering the beamforming of the existing access point, or increasing the power provided to or utilized by the existing access point. In another example, if the demand is less than a particular threshold (based on a count of the RACH and LAU/RAU attempts), the importance of the coverage gap may indicate the MNO does not need to take immediate action.

### Example Satellite

Having described the example embodiments discussed above of the presently disclosed technology, an example operating environment of an example satellite (e.g., satellite 150 of FIG. 1) is described below with respect to FIG. 4. Example environment 400 is but one example of a suitable satellite environment, and is not intended to suggest any particular limitation as to the scope of use or functionality of the technology disclosed. Neither should satellite 402 be interpreted as having any dependency or requirement relating to any particular component illustrated, or a particular combination of the components illustrated in FIG. 4.

As illustrated in FIG. 4, example satellite 402 includes antenna(s) 404, transponder(s) 406, power system(s) 408, an orientation and stabilization system 410, sensor(s) 412, database(s) 414, real-time data collector 416, propulsion system 418, and processor(s) 420. The antenna(s) 404 of the satellite 402 can be configured to communicate with user devices, gateways, other satellites, other nodes, or one or more combinations thereof. The antenna(s) 404 may be based on one or more antenna elements (e.g., monopoles or dipoles, loop antennas, helical antennas, patch antennas, inverted-F antennas, Yagi antennas, slot antennas, horn antennas, cavity antennas) and can be used in one or more antenna arrays (e.g., phased antenna arrays, fixed direct radiating arrays, deployable direct radiating antenna arrays, space fed arrays, reflector fed arrays).

Transceiver circuitry of the satellite 402 may include transponder(s) 406 capable of receiving uplink signals and capable of transmitting downlink signals. For example, the transponder(s) 406 may receive, amplify, or retransmit one or more signals between the satellite 402 and a gateway or user device, for example. As another example, one or more of the transponder(s) 406 can operate within a particular frequency band. In some embodiments, the transponder(s) 406 can perform a bent-pipe transmission. In some embodiments, one or more of the transponder(s) 406 can operate in a single-channel per carrier mode, a time-division multiple access mode, another type of mode, or one or more combinations thereof.

The power system(s) 408 can supply power to the satellite 402. For example, the power system(s) 408 may include one or more solar panels, one or more arrays of solar panels, power regulator circuitry, one or more batteries (e.g., silver zinc cell, lithium cell, solar cell), another type of power system component, or one or more combinations thereof. The power system(s) may also store electrical power generated from solar energy. The orientation and stabilization system 410 can act as a stabilizer (e.g., spin stabilization or three-axis (e.g., yaw axis, roll axis, and pitch axis) stabilization). The orientation and stabilization system 410 may also modify or control the spin and rotation of the satellite 402 (e.g., speed of rotation).

The sensor(s) 412 may include a sun sensor for detecting the director or position of the sun, an earth sensor for detecting the direction or position of the earth, light-based sensors (e.g., infrared sensors, visible light sensors, ultraviolet sensors), LIDAR, radar, backscattered light or backscattered radio-frequency signal sensors, temperature sensors, radiation sensors, accelerometers, gyroscopes, magnetic sensors, spectrometers, microwave sensors, particle detectors, another type of sensor, or one or more combinations thereof. The database(s) 414 may include one or more of a telemetry database, a payload database, an orbital database, a command and control database, a mission planning database, a reference database (e.g., for storing celestial data), a ground station database (e.g., for storing data from communications with terrestrial devices), another type of database, or one or more combinations thereof.

The real-time data collector 416 is initially assigned a dummy PLMN ID is assigned to a space mobile satellite. As described, the dummy PLMN ID can be utilized to receive data from a UE without providing any services to the UE. The real-time data collector may receive data such as RACH and LAU/RAU as a function of beam location for a terrestrial network. Additionally or alternatively, the data may also include a SIM assigned to an IMSI for each UE. Additionally or alternatively, the data may include a signal strength corresponding to each UE via brute force PCI scanning. In some aspects, the PCI may be changed or altered for each satellite pass. For example, on each pass, one or more PCI may be changed (such as by incrementing the PCI from the previous pass) and data can be collected from the UE to assess how strong the signal strength (e.g., RSRP/RSSI is for the MNO network and/or a competitor MNO network. In some aspects, the satellite tracks demand based on the RACH and the LAU/RAU attempts within a particular area.

The propulsion system 418 can control the orbit of the satellite 402. For example, the propulsion system 418 can correspond to chemical propulsion, electric propulsion, compressed gas propulsion, hybrid propulsion, another type of propulsion, or one or more combinations thereof. The processor(s) 420 can be utilized by or for one or more of the antenna(s) 404, transponder(s) 406, power system(s) 408, orientation and stabilization system 410, sensor(s) 412, database(s) 414, real-time data collector 416, propulsion system 418, another satellite component, or one or more combinations thereof. For example, the processor(s) 420 can process sensor data and determine the next satellite pass parameter. In an example embodiment, the processor(s) 420 can be a central processing unit, a digital signal processor, a field-programmable gate array, a graphics processing unit, a system-on-chip, a radiation-tolerant processor, another type of processor, or one or more combinations thereof.

### Example User Device

Having described the example embodiments discussed above of the presently disclosed technology, an example operating environment of an example user device (e.g., user device 102 of FIG. 1) is described below with respect to FIG. 5. User device 500 is but one example of a suitable computing environment, and is not intended to suggest any particular limitation as to the scope of use or functionality of the technology disclosed. Neither should user device 500 be interpreted as having any dependency or requirement relating to any particular component illustrated, or a particular combination of the components illustrated in FIG. 5.

As illustrated in FIG. 5, example user device 500 includes a bus 502 that directly or indirectly couples the following devices: memory 504, one or more processors 506, one or more presentation components 508, one or more input/output (I/O) ports 510, one or more I/O components 512, a power supply 514, and one or more radios 516.

Bus 502 represents what may be one or more busses (such as an address bus, data bus, or combination thereof). Although the various blocks of FIG. 5 are shown with lines for the sake of clarity, in reality, these blocks represent logical, not necessarily actual, components. For example, one may consider a presentation component, such as a display device, to be an I/O component. Also, processors have memory. Accordingly, FIG. 5 is merely illustrative of an exemplary user device that can be used in connection with one or more embodiments of the technology disclosed herein.

User device 500 can include a variety of computer-readable media. Computer-readable media can be any available media that can be accessed by user device 500 and may include both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information, such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium which can be used to store the desired information and which can be accessed by user device 500. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. One or more combinations of any of the above should also be included within the scope of computer-readable media.

Memory 504 includes computer storage media in the form of volatile and/or nonvolatile memory. The memory 504 may be removable, non-removable, or a combination thereof. Example hardware devices of memory 504 may include solid-state memory, hard drives, optical-disc drives, other hardware, or one or more combinations thereof. As indicated above, the computer storage media of the memory 504 may include RAM, Dynamic RAM, ROM, EEPROM, flash memory or other memory technology, CD-ROM, a cache memory, DVDs or other optical disk storage, magnetic cassettes, magnetic tape, magnetic disk storage or other magnetic storage devices, a short-term memory unit, a long-term memory unit, any other medium which can be used to store the desired information and which can be accessed by user device 500, or one or more combinations thereof.

The one or more processors 506 of user device 500 can read data from various entities, such as the memory 504 or the I/O component(s) 512. The one or more processors 506 may include, for example, one or more microprocessors, one or more CPUs, a digital signal processor, one or more cores, a host processor, a controller, a chip, a microchip, one or more circuits, a logic unit, an integrated circuit (IC), an application-specific IC (ASIC), any other suitable multi-purpose or specific processor or controller, or one or more combinations thereof. In addition, the one or more processors 506 can execute instructions, for example, of an operating system of the user device 500 or of one or more suitable applications.

The one or more presentation components 508 can present data indications via user device 500, another user device, or a combination thereof. Example presentation components 508 may include a display device, speaker, printing component, vibrating component, another type of presentation component, or one or more combinations thereof. In some embodiments, the one or more presentation components 508 may comprise one or more applications or services on a user device, across a plurality of user devices, or in the cloud. The one or more presentation components 508 can generate user interface features, such as graphics, buttons, sliders, menus, lists, prompts, charts, audio prompts, alerts, vibrations, pop-ups, notification-bar or status-bar items, in-app notifications, other user interface features, or one or more combinations thereof.

The one or more I/O ports 510 allow user device 500 to be logically coupled to other devices, including the one or more I/O components 512, some of which may be built in. Example I/O components 512 can include a microphone, joystick, game pad, satellite dish, scanner, printer, wireless device, and the like. The one or more I/O components 512 may, for example, provide a natural user interface (NUI) that processes air gestures, voice, or other physiological inputs generated by a user. In some instances, the inputs the user generates may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with the one or more presentation components 508 on the user device 500. In some embodiments, the user device 500 may be equipped with one or more imaging devices, such as one or more depth cameras, one or more stereoscopic cameras, one or more infrared cameras, one or more RGB cameras, another type of imaging device, or one or more combinations thereof, (e.g., for gesture detection and recognition). Additionally, the user device 500 may, additionally or alternatively, be equipped with accelerometers or gyroscopes that enable detection of motion. In some embodiments, the output of the accelerometers or gyroscopes may be provided to the one or more presentation components 508 of the user device 500 to render immersive augmented reality or virtual reality.

The power supply 514 of user device 500 may be implemented as one or more batteries or another power source for providing power to components of the user device 500. In embodiments, the power supply 514 can include an external power supply, such as an AC adapter or a powered docking cradle that supplements or recharges the one or more batteries. In aspects, the external power supply can override one or more batteries or another type of power source located within the user device 500.

Some embodiments of user device 500 may include one or more radios 516 (or similar wireless communication components). The one or more radios 516 can transmit, receive, or both transmit and receive signals for wireless communications. In embodiments, the user device 500 may be a wireless terminal adapted to receive communications and media over various wireless networks. User device 500 may communicate using the one or more radios 516 via one or more wireless protocols, such as code division multiple access (“CDMA”), global system for mobiles (“GSM”), time division multiple access (“TDMA”), another type of wireless protocol, or one or more combinations thereof. In embodiments, the wireless communications may include one or more short-range connections (e.g., a Wi-Fi® connection, a Bluetooth connection, a near-field communication connection), a long-range connection (e.g., CDMA, GPRS, GSM, TDMA, 802.16 protocols), or one or more combinations thereof. In some embodiments, the one or more radios 516 may facilitate communication via radio frequency signals, frames, blocks, transmission streams, packets, messages, data items, data, another type of wireless communication, or one or more combinations thereof. The one or more radios 516 may be capable of transmitting, receiving, or both transmitting and receiving wireless communications via mm waves, FD-MIMO, massive MIMO, 3G, 4G, 5G, 6G, another type of Generation, 802.11 protocols and techniques, another type of wireless communication, or one or more combinations thereof.

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software. For instance, various functions may be carried out by a processor executing instructions stored in memory. As such, other arrangements and elements (for example, machines, interfaces, functions, orders, and groupings of functions, and the like) can be used in addition to, or instead of, those shown.

Embodiments of the present disclosure have been described with the intent to be illustrative rather than restrictive. Embodiments described in the paragraphs above may be combined with one or more of the specifically described alternatives. In particular, an embodiment that is claimed may contain a reference, in the alternative, to more than one other embodiment. The embodiment that is claimed may specify a further limitation of the subject matter claimed. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

The invention claimed is:

1. A system for identifying terrestrial network coverage gaps using real-time data gathered by space mobile systems, the system comprising:
one or more processors; and
computer memory storing computer-usable instructions that, when executed by the one or more processors, cause the one or more processors to perform operations comprising:
assigning a dummy public land mobile network (PLMN) identifier (ID) to a space mobile satellite;
receiving, from the space mobile satellite, a random access channel (RACH) and location and routing area updates (LAU/RAU) as a function of beam location for a terrestrial network; and
based on a subscriber identity module (SIM) assigned to an international mobile subscriber identity (IMSI) of one or more user devices, categorizing a coverage deficiency for a terrestrial network.

2. The system of claim 1, further comprising identifying a signal strength corresponding to the one or more user devices via brute force physical cell identity (PCI) scanning.

3. The system of claim 2, further comprising utilizing the signal strength corresponding to the one or more user devices, generating a coverage map for a mobile network operator (MNO) or a competitor MNO.

4. The system of claim 3, further comprising, identifying a coverage gap for the MNO or the competitor MNO.

5. The system of claim 4, further comprising defining demand based on the RACH and the LAU/RAU attempts within the coverage gap.

6. The system of claim 5, further comprising determining an importance of the coverage gap based on the demand.

7. The system of claim 2, wherein the brute force PCI comprises altering the PCI for each satellite pass.

8. A method for identifying terrestrial network coverage gaps using real-time data gathered by space mobile systems, the method comprising:
assigning a dummy public land mobile network (PLMN) identifier (ID) to a space mobile satellite;
receiving, from the space mobile satellite, a random access channel (RACH) and location and routing area updates (LAU/RAU) as a function of beam location for a terrestrial network; and
based on a subscriber identity module (SIM) assigned to an international mobile subscriber identity (IMSI) of one or more user devices, categorizing a coverage deficiency for a terrestrial network.

9. The method of claim 8, further comprising identifying a signal strength corresponding to the one or more user devices via brute force physical cell identity (PCI) scanning.

10. The method of claim 9, further comprising utilizing the signal strength corresponding to the one or more user devices, generating a coverage map for a mobile network operator (MNO) or a competitor MNO.

11. The method of claim 10, further comprising, identifying a coverage gap for the MNO or the competitor MNO.

12. The method of claim 11, further comprising defining demand based on the RACH and the LAU/RAU attempts within the coverage gap.

13. The method of claim 12, further comprising determining an importance of the coverage gap based on the demand.

14. The method of claim 9, wherein the brute force PCI comprises altering the PCI for each satellite pass.

15. One or more non-transitory computer storage media having computer-executable instructions embodied thereon, that when executed by at least one processor, cause the at least one processor to perform a method comprising:
assigning a dummy public land mobile network (PLMN) identifier (ID) to a space mobile satellite;
receiving, from the space mobile satellite, a random access channel (RACH) and location and routing area updates (LAU/RAU) as a function of beam location for a terrestrial network; and
based on a subscriber identity module (SIM) assigned to an international mobile subscriber identity (IMSI) of one or more user devices, categorizing a coverage deficiency for a terrestrial network.

16. The one or more non-transitory computer storage media of claim 15, further comprising identifying a signal strength corresponding to the one or more user devices via brute force physical cell identity (PCI) scanning.

17. The one or more non-transitory computer storage media of claim 16, further comprising utilizing the signal strength corresponding to the one or more user devices, generating a coverage map for a mobile network operator (MNO) or a competitor MNO.

18. The one or more non-transitory computer storage media of claim 17, further comprising, identifying a coverage gap for the MNO or the competitor MNO.

19. The one or more non-transitory computer storage media of claim 18, further comprising defining demand based on the RACH and the LAU/RAU attempts within the coverage gap.

20. The one or more non-transitory computer storage media of claim 19, further comprising determining an importance of the coverage gap based on the demand.
